(19) United States
(12) Patent Application Publication
(10) Pub. No.: US 2010/0011768 A1
(43) Pub. Date: Jan. 21, 2010

(54) Pyrodielectrophoretic Heat Engine And Method Of Energy Conversion

(76) Inventor: James Scott Hacsi, Pueblo, CO (US)

Correspondence Address: JAMES SCOTT HACSI, 13 DARTMOUTH AVENUE, PUEBLO, CO, 81005, US

(21) Appl. No.: 11/757,377

(22) Filed: Jun. 3, 2007

(51) Int. Cl. F03G 7/00

(52) U.S. Cl. 60/721

(57) ABSTRACT

A pyrodielectrophoretic heat engine and energy conversion method exploiting the pyrodielectrophoretic effect for effectively and efficiently converting thermal energy into work or other useful forms at any physical size or scale.

### CROSS-REFERENCE TO RELATED APPLICATIONS

Not applicable

### STATEMENT REGARDING FEDERALLY SPONSORED RESEARCH

Not applicable

### SEQUENCE LISTING OR PROGRAM

Not applicable

### BACKGROUND OF THE INVENTION

1. Field of the Invention

The present invention relates to thermodynamic heat engines and heat cycles for the conversion of heat or thermal energy directly into work or more useful forms.

2. Description of Prior Art

As sensors and actuators become smaller, there is a continuing and growing need for micro-power sources that efficiently convert heat energy into more useful forms at very small physical scales. The technology to build extremely small heat engines is available, but there are currently no heat engines or heat cycles that work efficiently, if at all, at such small physical dimensions.

Fossil fuels are a non-renewable energy source that must be used wisely. Unfortunately, all known and currently available heat engines and thermodynamic heat cycles prevent the efficient conversion of energy from valuable non-renewable resources. That means we are consuming precious, non-renewable energy resources today in inefficient thermodynamic processes and whatever energy is wasted in those processes is lost forever.

Current ferroelectric power converters include stacked capacitors having temperature dependent capacitance and the use of reeds which serve as thermal switches and are caused to vibrate by the flow of vapor carrying heat between stages, thereby pulsing the heat at the proper frequency and phase through the stacked capacitors. Another known device exploits a somewhat different concept in an energy conversion system in which a first material within the region between the electrodes of a capacitor is replaced, following charging of the capacitor, by a second material having a lower dielectric constant than the first material. The capacitor is then discharged and the first material is restored to the region between the capacitor electrodes for subsequent recharging. Another approach uses a material with a dielectric constant different from that of a vacuum which is inserted between capacitor electrodes. In this case, mechanical work is performed against an electric field and the device is essentially the same as an electromagnetic motor. This approach is different from using pyroelectric materials and the electrocaloric effect, because it uses capacitance change at a constant charge. In the case of pyroelectric action, the charge is changing according to the temperature change. If the relative dielectric constant is also changing with temperature, it is a side effect.

A further approach uses the electrocaloric effect for pyroelectric conversion of heat into electricity. However, this approach has a large time constant because the pyroelectric material is mechanically moved from the hot to cold zone, or worse yet, a cyclic heat source is employed. There have been attempts in the past to use the temperature-dependent permittivity characteristic of ferroelectric materials for the conversion of heat directly into electricity where the ferroelectric material is used as the dielectric in a parallel-plate capacitor. Hoh describes and claims in U.S. Pat. No. 3,243,687 dated Mar. 29, 1966 and entitled “Energy Converter” an invention exploiting what was defined as the “thermo-dielectric effect” which utilizes the rise or fall in the dielectric constant of dielectric matter in a capacitor as it is heated or cooled. Hoh anticipated using the increase or decrease in voltage and thus, the amount of energy gained in an energized capacitor with isolated electric charges when it is heated or cooled for the direct conversion of thermal energy into electricity. Ferroelectric direct-conversion devices of this nature are impractical because a capacitor that has a dielectric with temperature-dependent permittivity must be physically moved through a heat cycle. Some devices even require a cyclical heat source. With respect to devices deriving electrical energy by thermally cycling capacitors with temperature dependent properties, the small efficiencies and low power densities have apparently precluded their use in any practical application for the production of electrical energy. Simply put, the conversion efficiency of such devices is very low because getting heat effectively into and out of the dielectric material of the capacitor has proven to be a difficult task.

A novel method of energy conversion was introduced in U.S. patent application Ser. No. 11/490,757 (Hacsi, filed July, 2006) that takes an entirely new approach using the “thermodielectrophoretic effect”. The newly introduced effect of that particular invention, however, relies on a change in permittivity in movable dielectric matter as it is drawn into or displaced from an electric field. A stationary electric field draws in moving dielectric matter with temporary relatively higher electric permittivity caused by heating or cooling, while displacing dielectric matter with temporary relatively lower electric permittivity caused by heating or cooling. The force of which the external electric field draws in dielectric matter in that invention is dependent upon the strength of a single electric field, but a much greater force would be obtainable if two or more independent electric fields acted together in a complementary fashion to draw the dielectric matter or displace the dielectric matter into or out of the electric field, respectively.

### OBJECTS AND ADVANTAGES

It would therefore be advantageous to provide a heat engine that does not require a cyclical heat source, has a minimum of moving parts, and converts thermal energy into kinetic energy or more useful forms very efficiently at even the smallest physical scales. Moreover, it would also be advantageous to provide a heat engine and heat cycle using the characteristic of pyroelectric materials where an electric field arises along a specific axis or where opposite electric charges temporarily reside on the material's top and bottom surfaces only when the material experiences a change in temperature. It would then be very advantageous to utilize a means for inducing a separate electric field in dielectric matter and have that dielectric matter drawn into an external electric field with a greater force than what was achievable by exploiting the “thermodielectrophoretic effect” as done in the invention described in U.S. patent application Ser. No. 11/490,757 (Hacsi, filed July, 2006).

A heat engine that first converts thermal energy efficiently into motion or kinetic energy would also be advantageous over the less efficient methods available for converting thermal energy directly into electricity. Consider a novel pyrodielectrophoretic heat engine with its associated heat cycle that exploits the “pyrodielectrophoretic effect”, also known as “pyrodielectrophoresis” (or pDEP). The “pyrodielectrophoretic effect” is hereby defined as the tendency of an external electric field to attract and draw in pyroelectric matter with a temporary surface electric charge or electric dipole moment caused by a change in temperature and spontaneous polarization, while simultaneously rejecting or displacing other pyroelectric matter from the same electric field that no longer has a surface electric charge or electric dipole moment and is no longer experiencing a change in temperature. In other words, pyroelectric matter acting as the dielectric of a parallel-plate capacitor that is experiencing a change in temperature and with a surface electric charge or electric dipole moment is drawn into the gap between the capacitor's plates, while other sections of the same pyroelectric dielectric matter is displaced from between the parallel, oppositely-charged plates because those sections of pyroelectric dielectric matter are no longer experiencing a change in temperature and no longer have a surface electric charge or no electric dipole moment. The result will then be a continuous motion of pyroelectric dielectric matter through the electric field of the capacitor as appropriate sections of the pyroelectric matter are heated (or cooled) and drawn into the non-uniform electric field or “fringe field” of the capacitor, while other sections of pyroelectric matter are cooled (or heated) until there is no longer a change in temperature in those sections of pyroelectric matter that are already inside the electric field of the capacitor. The kinetic energy of the moving pyroelectric (dielectric) matter can then be efficiently converted to electrical energy or other useful forms. Notice this procedure is entirely different than heating and cooling a capacitor with its stationary dielectric having temperature-dependent permittivity for the purpose of converting heat directly into electric energy. In this case, the dielectric of the capacitor actually moves while doing work and the plates remain stationary so that the pyroelectric dielectric matter essentially becomes the working substance or “fluid” of the heat cycle. An indirect conversion of heat to mechanical energy and then into electric energy or other useful forms occurs. The permanently-fixed or stationary electric field drawing in and displacing the pyroelectric slab can be established and maintained by a separate voltage or power source, but the electric field can also be induced by being in close physical proximity to the heated or cooled sections of pyroelectric matter that are experiencing a temperature change.

In pyroelectrics, the material has a spontaneous dipole moment as a result of the ionic positions and the dipole moment induces a polarization. Depending on the formation of the pyroelectric, the pyroelectric may possess a net polarization and the polarization will increase when a stress is applied to the material, as it is piezoelectric, but it will not reverse under the application of an electric field. As its temperature increases, the polarization of pyroelectric matter increases and this leads to the development of electric charge on the surface of the pyroelectric which will produce electric current in a closed circuit. This then indicates the pyroelectric slab will be drawn into the gap between the capacitor's plates whether the plates are oppositely-charged or not. If the plates are uncharged, then the charges on the surface of the sections of pyroelectric slab experiencing a temperature change will induce an electric field in the plates. The induced electric field of the plates will attempt to draw the sections of slab experiencing a temperature change closer and into the gap between the plates. A non-induced electric field, as established by an external voltage or power source and applied so as to make the capacitor's plates oppositely-charged electrically, will of course result in an increase in the force drawing the heated (or cooled) sections of pyroelectric slab into the capacitor's gap when the two complementing electric fields work together. Moreover, there is no need for the surface electric charges to be drawn off the pyroelectric slab and made to move as current in an external electric circuit because the coulombic forces between stationary electric charges are sufficient to move the pyroelectric slab through the heat cycle. However, the electric charge can be drawn from the surface and made to flow through an external circuit if the present invention is used as a sensor. In that case, the sensor will generate power for its own operation while detecting or sensing heat or electromagnetic radiation!

Any material develops a dielectric polarization when an electric field is applied, but a substance which has such a natural charge separation even in the absence of a field is called a polar material. Whether or not a material is polar is determined solely by its crystal structure and all polar crystals are pyroelectric. There are ten polar crystal classes and they are generally referred to as the pyroelectric classes. The property of pyroelectricity is the measured change in net polarization (a vector) proportional to a change in temperature. The total pyroelectric coefficient measured at constant stress is the sum of the pyroelectric coefficients at constant strain (primary pyroelectric effect) and the piezoelectric contribution from thermal expansion (secondary pyroelectric effect).

Under normal circumstances, even polar materials do not display a net dipole moment because the intrinsic dipole moment is neutralized by free electric charge that builds up on the surface by internal conduction or from the ambient atmosphere. Polar crystals only reveal their nature when perturbed in some fashion that momentarily upsets the balance with the compensating surface charge (such as a change in temperature). As mentioned, the surface charge due to spontaneous polarization of a pyroelectric crystal is neutralized by free carriers from the interior and exterior of the crystal. The average time needed for interior free charges to neutralize surface charges is derived by dividing the dielectric constant by the conductivity of the crystal. These values range from 1 second to 1000 seconds for most pyroelectric materials. This is an important aspect because if free charges from the ambiance are not present to neutralize surface charges, then the surface charge due to a temperature change and from spontaneous polarization will reside for a predicable and relatively long period of time.

The maximum electric field which arises due to a temperature shift in the pyroelectric slab is:

$$E = \frac{α Δ T}{{K}_{3} {ɛ}_{0}}$$

where E=induced electric field [volts m⁻¹], α=pyroelectric coefficient [C K⁻¹ m²], ΔT=temperature difference [K], K₃=dielectric constant and ∈₀=permittivity of free space [Fm⁻¹]. For PZT piezoceramic, α is typically ˜400×10⁻⁶ C K⁻¹ m². It is then evident that a high pyroelectric coefficient and a large temperature difference with a minimal dielectric constant will result in a maximum electric field. Thus, the operating temperature range of each particular pyroelectric material being cycled must be carefully selected so the dielectric constant is large enough to allow surface charges to reside for an optimum amount of time without being neutralized by free internal charges, while still being small enough to result in a large electric field during a required temperature shift. This would mean, however, that the operating temperature range will most likely not be near the Curie point of the particular pyroelectric material being used in the heat engine.

The invention as described in U.S. patent application Ser. No. 11/490,757 (Hacsi, filed in July, 2006) on the other hand, takes advantage of a large anomalous increase in permittivity (dielectric constant) near a Curie point of the working ferroelectric substance for converting heat into other useful forms. Ideally, pyroelectric materials used in the present invention should have a large temperature change rate, which means the material should have a small specific heat, low density, and small physical dimensions making the present invention most effective and efficient at the smallest of physical scales (nanometer or micrometer sizes).

Using the conventional approximate equations for the properties of a parallel-plate capacitor, it can readily be shown that the electrostatic field pulls a dielectric slab toward (partly offset in the gap) a central position in the gap with a force, F, that depends on the square of the potential (voltage) applied between the electrode plates, the length of an electrode plate, and the thickness of the gap between the plates. Typically, the force is small from a macroscopic human perspective. However, the force depends on the ratio between the capacitor dimensions, but does not depend on the size. In other words, the force remains the same if the capacitor and the dielectric slab are shrunk to very small dimensions (nanometer size). At the same time, the masses of all components are proportional to the third power of their linear dimensions. Therefore, the force-to-mass ratio and, consequently, the acceleration that can be imparted to a dielectric slab (or pyroelectric slab in this case) are much larger at very small physical scales than at the macroscopic scale.

To use these concepts in a heat engine, consider a thin dielectric slab of pyroelectric material that is placed near a set of oppositely-charged plates of a parallel-plate capacitor. If heat is applied causing a rise in temperature of an isolated section of the pyroelectric slab, spontaneous polarization will rise and electric charges will appear on the top and bottom surfaces of the pyroelectric slab causing a net force drawing the slab into alignment between the two capacitor plates. Of course, the axis of polarization or the pyroelectric slab must be conducive to this action. The surface conductivity of the pyroelectric slab must be low, so the surface-charge distribution will be concentrated and localized only around a relatively small heated volume of the slab. More importantly, once the heated portion of slab is drawn into alignment between the plates, cooling of the inserted areas of slab will occur (since the heat is essentially removed), thus causing the localized electric field charges to disappear or be reduced considerably in those sections of slab. This would mean that as long as the portions of slab located in the fringe-electric field (non-uniform) are experiencing a temperature change (heated or cooled) while the sections of slab located between the plates are not, then a net continuous motion of the slab through the established electric field will result! Appropriately applied heat will cause surface charges to appear where they are most effective, and cooling of the slab inside the plates will cause the electric charges to disappear as needed so that new heated sections are continuously drawn in while cooled sections of slab are simultaneously displaced. Heat can be applied from any heat source such as radioisotope or solar.

Thus, the method of energy conversion, as explained, exploits the pyrodielectrophoretic effect and it should then be evident that work can be performed by the pryoelectric dielectric slab as it continuously moves through an electric field. Thermal energy is directly converted to mechanical or kinetic energy. Kinetic energy of the slab can then be converted to electrical energy and the system conversion efficiency and power output will be greater than the amount of electric power that can be generated or converted with direct heat-to-electric energy conversion as is now being done with pyroelectric generators.

### OBJECTS AND ADVANTAGES

Accordingly, besides the objects and advantages of the heat engine and associated heat cycle as described above, several advantages of the present invention are:
(a) to provide heat engines capable of converting heat with relatively small variations in temperature directly into mechanical energy or motion;
(b) to provide simple heat engines which have relatively high power density, high specific power and high Carnot efficiencies.
(c) to provide simple heat engines with few moving parts and which can be produced cost-effectively;
(d) to provide heat engines that can be constructed to operate at very small physical scales;
(e) to provide heat engines capable of converting low-grade waste heat or solar energy directly into mechanical energy or motion;
(f) to provide means and methods of cooling electronic circuits and components with very small dimensions;
(g) to provide means and methods for pumping or moving matter very efficiently at small physical scales, and
(h) to provide sensitive and tiny sensors requiring very little electrical power for their operation.

### SUMMARY

In accordance with the present invention, a pyrodielectrophoretic heat engine is provided that operates on a novel thermodynamic heat cycle which exploits the pyrodielectrophoretic effect as defined herein for converting heat or thermal energy directly into work or more useful forms even at very small physical scales for the purposes of cooling, pumping, or moving matter, or for making tiny sensors, and for producing electricity more effectively and efficiently.

### DRAWING FIGURES

FIG. 1 illustrates basic components needed in a pyrodielectrophoretic heat engine for converting heat into mechanical energy or motion by exploiting the pyrodielectrophoretic effect when a voltage or power supply is used to energize two oppositely-charged plates.

FIG. 2 shows a heat engine as a preferred embodiment of the present invention which exploits the pyrodielectrophoretic effect without the use of an external power supply or voltage source.

### REFERENCE NUMERALS

1 flexible pyroelectric ribbon
2 heat or electromagnetic radiation source
3 heat sink
4 negatively-charged electrode
5 positively-charged electrode
6 electrically conductive uncharged electrode
7 voltage or power source

### DETAILED DESCRIPTION OF THE DRAWING FIGURES

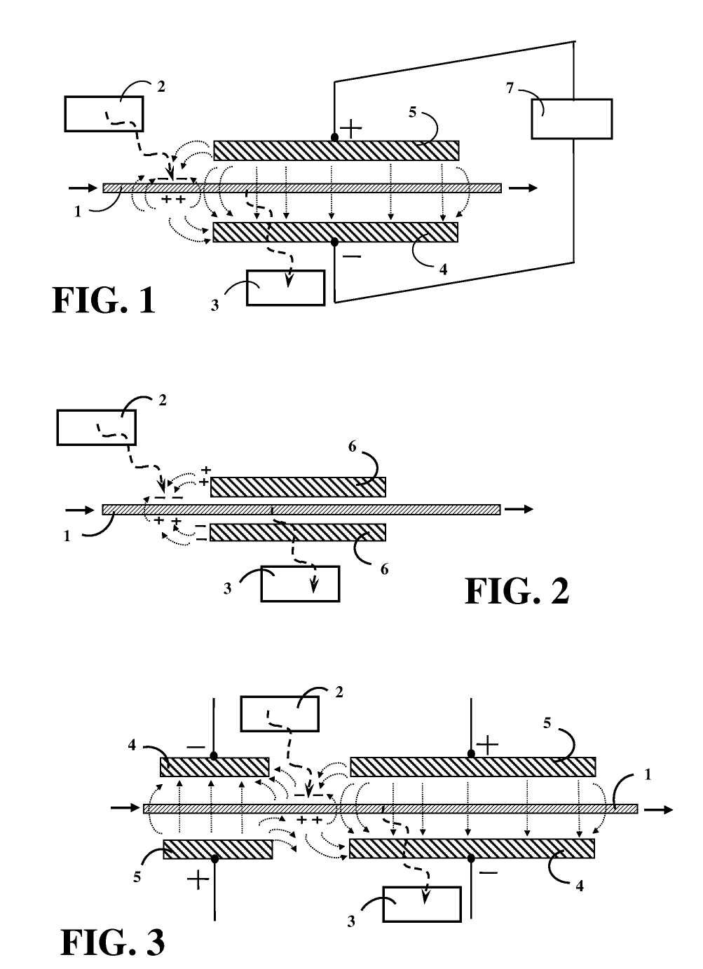

FIG. 1 shows the basic components needed in a heat engine or a preferred embodiment of the present invention that exploits the pyrodielectrophoretic effect. A negatively-charged electrode 4 and a positively-charged electrode 5 are energized by a voltage or power source 7. A ribbon comprised of pyroelectric matter 1 fills the gap between the negatively-charged electrode 4 and the positively-charged electrode 5. Heat or radiation is supplied by a heat source 2 and a heat sink 3 absorbs waste heat from the pyroelectric ribbon 1. The heat source 2 is comprised of a means for changing the temperature in a small section of the ribbon.

FIG. 2 shows the basic components needed in a heat engine that exploits the pyrodielectrophoretic effect. Two stationary electrically-conductive plates are shown that are not energized by a power or voltage source. A ribbon comprised of pyroelectric matter 1 fills the gap between the two uncharged electrodes. Heat or radiation is supplied by a heat source 2 and a heat sink 3 absorbs waste heat from the pyroelectric ribbon 1. The heat source is comprised of a means for changing the temperature in a small section of the ribbon. Thus, the heat source is comprised of a means for supplying thermal energy of any sort which includes, but is not limited to, electromagnetic energy, such as microwaves, gamma rays, or any other heat, such as low-grade waste heat from other thermodynamic processes. The heat sink 3 can be comprised of any means for directing waste heat away from the pyroelectric matter.

FIG. 3 shows the same basic heat engine components except a second set of oppositely-charged plates are added that will “push” or repel the electric field or surface electric charge established in or on the pyroelectric matter when a temperature change exists in the pyroelectric matter

### Operation

In FIG. 1, a basic heat engine is shown that exploits and demonstrates the pyrodielectrophoretic effect. A negatively-charged electrode 4 and a positively-charged electrode 5 are energized by the voltage source 7. Heat or electromagnetic radiation is applied to the pyroelectric ribbon 1 just outside the two oppositely-energized plates or in the “fringe” non-uniform section of the electric field established between the plates. The temperature change and spontaneous polarization in that specific localized section of pyroelectric matter causes an isolated surface electric charge and electric field to appear. The axis of polarization in the pyroelectric matter is perpendicular to the movement of the pyroelectric matter into the gap between the plates. As shown in the drawing, the two electric fields complement each other and as a result, coulombic forces attempt to pull the heated section of pyroelectric matter into the gap and align it with the two plates.

After the electric forces between the two charged plates and the heated section of pyroelectric matter draw that particular section into the gap between the plates, it will quickly cool because it has been removed from the heat source. The temperature change in that section of pyroelectric matter will diminish and so will the surface electric charge and associated electric field so that the force keeping the pyroelectric matter in the gap diminishes as well. Meanwhile, a new section of pyroelectric matter is brought into close proximity to, or is subjected to the heat source causing a temperature change and associated surface electric charge and electric field in that different isolated section of pyroelectric matter. The result will then be that the newly heated section of pyroelectric matter with a new electric field will be drawn into the gap between the oppositely-charged plates causing the cooled other section (with no surface electric charge or electric field) of pyroelectric matter to be displaced from the gap between the plates. Thus, as heat or radiation is supplied by the heat source at the appropriate location and time, it will cause temperature changes in different sections of the pyroelectric matter and the ribbon of pyroelectric matter will continuously move into and through the electric field established between the two stationary, oppositely-charged plates. The heat or radiation source causes the temperature changes to occur causing the surface electric charge and the complementing electric field to appear at just the right place and time, while the heat sink causes the pyroelectric matter to cool enough where the surface electric charge and electric field disappears for making it easy to displace the cooled pyroelectric matter from the gap between the plates.

FIG. 2 shows almost the same heat engine components except there is no voltage or electric power supplied to the two stationary conductive plates. When the section of pyroelectric matter in the ribbon just outside the plates is heat or irradiated, surface electric charges appear in that section establishing an electric field between the top and bottom surfaces. The axis of polarization is again perpendicular to the movement of the pyroelectric ribbon. Since the plates are comprised of electrically-conductive matter, opposite electric charges in the plates will be drawn or attracted to corresponding opposite electric charges present on the top and bottom surfaces of the pyroelectric ribbon. The heated or irradiated section of pyroelectric matter in the ribbon will be drawn into alignment between the two conductive plates containing the induced, complementing electric field. As one previously-heated section of pyroelectric matter in the ribbon fills the gap between the plates, that section is cooled by the heat sink until no temperature change exists and the surface electric charges disappear. However, a newly-heated or irradiated section of pyroelectric ribbon located just outside the plates will induce a complementing electric field in the uncharged conductive plates. That new section of pyroelectric matter will be drawn inside the gap between the stationary plates and the cooled section will be displaced from the gap between the plates. Again, the net result is a continuous movement of sections the pyroelectric ribbon moving into and out of the gap between the two conductive, uncharged plates as long as heat or radiation is applied to cause a temperature change to occur in the ribbon at just the right place and time.

FIG. 3 shows a similar heat engine and components with an added set of oppositely-charged conductive plates 6 that interacts with the electric field or surface electric charge in or on the pyroelectric ribbon as a section of the ribbon experiences a change in temperature. The extra set of charged plates aids or “pushes” the heated sections of ribbon into the gap between the other set of oppositely-charged plates when a section of ribbon experiences a change in temperature and has a temporary surface electric charge and electric field. Notice all the electric fields are established with polarities so they interact to force the pyroelectric ribbon into and through the gap between a set of oppositely-charged plates. Addition of the extra set of charged plates increases the effectiveness, power, and efficiency of the heat engine.

### Additional Embodiments

It should be evident to one skilled in the art that the pyroelectric matter used in the heat engine can be in any shape or form which allows sections of the pyroelectric matter to be moved into and through an electric field. That would mean the pyroelectric matter can be gaseous, liquid, or solid matter in the shape of a rotatable table, wheel, or disc sandwiched between, and which can move freely between, a set of stationary conductive plates or a fixed electric field in general. The pyroelectric matter can be also comprised of nanotubes, nanowires, or any nanostructure in the shape of a belt, or else the pyroelectric matter can be in the form or shape of a thin-film permanently mounted and bonded to a conductive rotatable table, wheel, or disc at any physical size or scale. It should also be obvious the pyrodielectrophoretic heat engine known to be the present invention can also be used for sensing or detecting changes in status of any desired energy, force, or parameter in any known substance for any application. For that matter, it should be evident that sensors can be designed for placement in remote locations where energy being sensed or detected is actually used to supply power to the sensors to radiate information to a central receiving point. Such sensors or detectors would require little or no power for their operation and they would thus operate for a long period of time as wireless remote sensors requiring no repair or attendance.

Since the physical and electrical characteristics of various types of pyroelectrics vary widely in different temperature ranges, it is conceivable to make pyrodielectrophoretic heat engines that include cascaded operating stages. Heat or radiation would be supplied to one stage and a certain amount of energy would be converted into work or other useful forms. The waste heat from that stage would be supplied to a next “lower” stage and more energy would be transformed into useful work or other forms. The last or “lowest” stage’ would discharge waste heat to the heat sink. It is then conceivable that several pyrodielectrophoretic heat engines, where each includes cascaded stages, are also arranged in a cascaded configuration to improve efficiency or power output. It should also be noted that work can be derived directly from each individual cascaded heat engine or each cascaded heat engine stage, but it is also conceivable that the heat engines and heat engine stages can all be “ganged” together on a common central shaft where they all work in unison and the kinetic energy of the rotating, common central shaft is converted to other useful forms with a single means for converting kinetic energy to those more useful forms.

It has not yet been definitely determined if or how the giant electrocaloric effect plays into the operation of the present invention, but it seems there is a cooling effect when certain ferroelectric materials, including pyroelectrics, are subjected to an external electric field. That would mean there is the possibility of using the heat engine known as the present invention operating on a reverse heat cycle, also known as a refrigeration cycle, for moving heat effectively and efficiently from one location to another.

The means for converting kinetic energy to more useful forms will depend on the size of the engine components and the particular application. For example, at small physical scales the working pyroelectric matter, such as the rotatable table would experience a large rotational torque, but at a relatively slow rotational speed (this of course may not be the case since heat flows differently at very small physical scales). A gear train can be used that significantly increases the rotational speed in order to drive a tiny electric generator can be utilized, where the slow speed of the table is increased hundreds of times. This concept is analogous to a clock spring that is wound very tightly, and where an escapement and gear train are used to drive the ‘minutes’ and ‘seconds’ hands of the clock at a much faster rate. Another means for converting kinetic energy of the rotatable table to more useful forms at small physical scales would be a cantilever that is stressed by moving pegs or gear teeth projecting from the rotatable table. The movement of each peg or tooth will apply a force to stress the cantilever in one direction and as the peg or tooth rotates beyond the reach of the stressed cantilever, the cantilever will spring back-and-forth with damped oscillations. The oscillating cantilever can then drive a piezoelectric generator for converting the motion of the cantilever into an electrical output.

Voltage can be applied to the electrodes in a pyrodielectrophoretic heat engine from any source for energizing the positively-charged and the negatively-charged electrodes. At small physical scales, for example, materials from the triboelectric series can be used where electrons are drawn off one electrode and deposited on the other electrode to cause a relatively high potential-difference between the electrodes by simply rubbing or brushing the appropriate moving materials together.

Tiny sensors and detectors can be devised that involve a linear or reciprocating action and that respond to electromagnetic radiation in the infrared and ultraviolet light spectrums. For instance, a pyroelectric slab of dielectric matter would be normally placed so it is offset in the gap between charged or uncharged plates of a parallel-plate capacitor. When light or electromagnetic radiation impinges on the exposed section of pyroelectric matter, that section will be drawn into full alignment in the gap between the plates due to coulombic forces present while a temperature change in the pyroelectric matter causes an appropriate surface electric charge and polarization. The force of the pyroelectric slab being drawn into the gap will be countered by a spring or some sort of flexible material that returns to a normal form or shape without applied stress. When the pyroelectric slab is drawn into the gap between the plates as it is irradiated, it will eventually be shaded from the electromagnetic radiation by the plates resulting in cooling until no temperature change exists in the material and until no electric field or surface charges are present. At that point, the spring or flexible material will move the pyroelectric slab back into position where it is again offset in the gap between the plates and exposed once again to the electromagnetic radiation. This type of self-reciprocating sensor or detector will indicate a continuous signal presence without the requirement for “chopping” the incoming radiation. Moreover, the movement and reciprocating action of the pyroelectric slab into and out of the gap can be converted to work or electricity for sending gathered information or data to a central collecting point (low-power wireless remote sensing).

Protein amino acid-based compounds have been synthesized and their single crystals were grown. The dielectric and pyroelectric properties of the crystals were studied in certain temperature ranges and it has been established that several compounds studied (L-His(H₃PO₄)₂, L-TyrHCl, L-Ala₂H₃PO₃.H₂O) are linear pyroelectrics, with their room-temperature pyroelectric figures of merit being close to those of ferroelectric triglycine sulfate crystals Collagen is the most abundant protein in mammals. The polar crystal structure of the collagen molecule means that it could exhibit a pyroelectric effect as well as piezoelectricity. It has low antigenicity associated with high biocompatibility and constitutes one of the major raw materials for biomaterial applications, which include pharmaceutical and medical areas. Collagen devices may be used as membranes sponges injectable material, support for slow drug delivery systems, coating of synthetic polymeric surfaces, and tubing, and so on. It could then be surmised that techniques for particle or human cell manipulation and sorting using the pyrodielectrophoretic effect at temperatures close to room-temperature would have a lost of biomedical applications.

### CONCLUSIONS, RAMIFICATIONS, AND SCOPE

Accordingly, the reader will see the pyrodielectrophoretic heat engine and associated heat cycle that exploit the pyrodielectrophoretic effect or pyrodielectrophoresis, can effectively and efficiently convert thermal energy from any source into kinetic energy, mechanical energy, work, or other useful forms. Furthermore, the heat engines and heat cycles exploiting the pyrodielectrophoretic effect provide the additional advantages of:
1. permitting the efficient conversion of thermal energy to more useful forms;
2. permitting effective heat engines at very small physical scales to operate and convert thermal energy to more useful forms;
3. allowing heat engines to be developed that are simple with few working parts and that can be cheaply-built;
4. permitting heat engines to convert low-grade heat that is normally wasted into useful work;
5. providing a means for pumping, moving, or otherwise relocating particles or objects of any shape, or composition at any physical scale or size;
6. allowing our country to become less-dependent upon foreign sources of non-renewable energy by permitting heat engines that operate more efficiently when converting precious resources into useful work.

Although the description above contains much specificity, this should not be construed as limiting the scope of the invention, but as merely providing illustrations of the presently preferred embodiments of this invention. There are many conceivable embodiments of the present invention, but any heat engine or associated heat cycle operating to convert heat into mechanical energy or more useful forms that is based on the pyrodielectrophoretic effect as defined herein, would be construed by a person skilled in the art as being an embodiment or object of the present invention. Thus, the scope of this invention should be determined by the appended claims and their legal equivalents, rather than by the examples given.

I claim:

1. A pyrodielectrophoretic heat engine exploiting the pyrodielectrophoretic effect for converting thermal energy into work or other useful forms, comprising:
(a) movable pyroelectric matter capable of exhibiting a temporary surface electric charge and electric field established or induced when said movable pyroelectric matter is subjected to an addition or removal of heat for causing a change in temperature, and
(b) a heat source or radiation source for causing a change in temperature in movable pyroelectric matter, and
(c) a heat sink for removing heat from or lowering the temperature of said movable pyroelectric matter, and
(d) a fixed electric field established between two oppositely-charged electrical points or surfaces capable of drawing in said movable pyroelectric matter with said temporary surface electric charge and electric field while simultaneously displacing from said fixed electric field other said movable pyroelectric matter with no said temporary surface electric charge or electric field and which is not experiencing said change in temperature.
(e) means for converting kinetic energy of said movable pyroelectric matter moving through said fixed electric field into said work or said other useful forms.

2. The pyrodielectrophoretic heat engine of claim 1 wherein said fixed electric field is not established by an outside power source or voltage source, but where said fixed electric field is instead caused, established, or induced into stationary electrically-conductive matter, such as the plates of a capacitor, by nearby surface electric charges or electric dipole moments present on or in sections of movable pyroelectric matter experiencing an addition or removal of heat for causing a change in temperature.

3. The pyrodielectrophoretic heat engine of claim 1 wherein said heat sink is used to cool said movable pyroelectric matter at the appropriate time and location for producing a temporary electric surface charge or electric dipole moment, while said heat source is used to heat said pyroelectric matter at another appropriate time and location until said temporary temperature change no longer exists in said movable pyroelectric matter and until said temporary surface electric charge or electric dipole moment diminishes entirely, whereby said pyrodielectrophoretic heat engine operates with a reverse thermodynamic heat cycle for converting heat energy into mechanical energy or other useful forms.

4. The pyrodielectrophoretic heat engine of claim 1 wherein said means for converting kinetic energy of said movable pyroelectric matter moving through said fixed electric field into said work or said other useful forms involves moving or pumping said movable pyroelectric matter acting as the working substance or working fluid in said pyrodielectrophoretic heat engine and where said movable pyroelectric matter is comprised of matter in the form of particles or objects of any size, shape, or composition, whereby said matter is moved from one physical or electrical location to another.

5. The pyrodielectrophoretic heat engine of claim 1 wherein said heat source is comprised of electromagnetic energy or electrically-charged particles applied to said movable pyroelectric matter for causing a change in temperature where said change in temperature causes a temporary surface electric charge or electric dipole moment, whereby energy contained in said electromagnetic waves or said electromagnetic rays is converted by said pyrodielectrophoretic heat engine into said work or said other useful forms both effectively and efficiently at any physical size or scale.

6. The pyrodielectrophoretic heat engine of claim 1 wherein said movable pyroelectric matter is in the form of a flexible belt, a flexible ribbon, a rotatable table, or a rotatable wheel.

7. The pyrodielectrophoretic heat engine of claim 1 wherein said movable pyroelectric matter is in the form of a thin-film bonded to a rotatable conductive table.

8. The pyrodielectrophoretic heat engine of claim 1 wherein said movable pyroelectric matter is comprised of nanotubes, nanowires, or any nano-structure capable of experiencing a surface electric charge, electric dipole moment, or electric field when exposed to an addition of heat, electromagnetic energy, or electrically-charged particles for causing a temporary change in temperature in said pyroelectric matter.

9. The pyrodielectrophoretic heat engine of claim 1 wherein said fixed electric field is established between two oppositely-charged electrical points or surfaces capable of drawing in or displacing said movable pyroelectric matter is generated and maintained by touching, rubbing, or otherwise contacting together, two or more electrically different materials selected from the triboelectric series in order to transfer electronic charges or ions and establish an electric potential difference between two electrical points.

10. The pyrodielectrophoretic heat engine of claim 1 wherein said fixed electric field established between two oppositely-charged electrical points or surfaces capable of drawing in or displacing said movable pyroelectric matter is established, generated, and maintained by electromagnetic waves, electromagnetic rays, or electrically-charged particles of matter emitted or transferred from radioactive matter.

11. The pyrodielectrophoretic heat engine of claim 1 wherein said heat source for supplying heat to or raising the temperature of movable pyroelectric matter is comprised of radioactive matter capable of emitting or transferring electromagnetic rays, electromagnetic waves, electrically-charged or uncharged particles of matter, or any type of heat-producing emission.

12. The dielectrophoretic heat engine of claim 1 wherein said heat source is comprised of means for directing, concentrating, or applying solar energy to cause a temporary change in temperature of said movable pyroelectric matter.

13. The pyrodielectrophoretic heat engine of claim 1 wherein said movable pyroelectric matter is in a solid, liquid, or gaseous state or form.

14. A method exploiting the pyrodielectrophoretic effect for converting thermal energy into work or other useful forms, comprising:
(a) providing a pyrodielectrophoretic heat engine exploiting the pyrodielectrophoretic effect for converting thermal energy into work or other useful forms, comprising a heat source or radiation source for causing a change in temperature in movable pyroelectric matter, and a heat sink for removing heat from or lowering the temperature of said movable pyroelectric matter, and said movable pyroelectric matter capable of exhibiting a temporary surface electric charge and electric field established or induced when said movable pyroelectric matter is subjected to an addition or removal of heat for causing a change in temperature, and a fixed electric field established between two oppositely-charged electrical points or surfaces capable of drawing in said movable pyroelectric matter with said temporary surface electric charge and electric field while simultaneously displacing from said fixed electric field other said movable pyroelectric matter with no said temporary surface electric charge or electric field and which is not experiencing said change in temperature, and means for converting kinetic energy of said movable pyroelectric matter moving through said fixed electric field into said work or said other useful forms, then
(b) heating or cooling provided said movable pyroelectric matter for causing said change in temperature in said movable pyroelectric matter where said change in temperature results in said temporary surface electric charge or electric field, then
(c) allowing said fixed electric field to draw in said movable pyroelectric matter with said temporary surface electric charge or electric field, then
(d) heating or cooling said movable pyroelectric matter already physically located inside said fixed electric field until said temperature change is no longer present in said movable pyroelectric matter for causing said surface electric charge or electric field to diminish or disappear entirely in said pyroelectric matter, then
(e) allowing said fixed electric field to displace said movable pyroelectric matter already physically located inside said fixed electric field where said movable pyroelectric matter is no longer experiencing said temperature change for causing said temporary surface electric charge or electric field in said movable pyroelectric matter, then
(f) continuously heating or cooling said movable pyroelectric matter and allowing said fixed electric field to draw in said movable pyroelectric matter with temporary said surface electric charge or electric dipole moment caused by said temperature change, while simultaneously and continuously displacing other said movable pyroelectric matter already physically located inside said fixed electric field with no said temporary surface electric charge or electric field, then
(g) converting kinetic energy of said movable pyroelectric matter being continuously drawn into and displaced from said fixed electric field into said work or said other useful forms,
whereby said thermal energy is converted by said pyrodielectrophoretic heat engine into said work or said other useful forms in a more effective and efficient manner at any physical size or scale.

15. A pyrodielectrophoretic heat engine and associated energy conversion method exploiting the pyrodielectrophoretic effect or pyrodielectrophoresis for moving or pumping pyroelectric matter of any size, shape or composition, or for sensing heat, temperature changes, or any type of electromagnetic radiation with any wavelength, or for the sensing and detection of emitted charged particles or rays, or for cooling matter, or for converting thermal energy into work or other useful forms.
